(19) United States
(12) Patent Application Publication
(10) Pub. No.: US 2011/0000322 A1
(43) Pub. Date: Jan. 6, 2011

(54) Sampling tools for powder

(75) Inventors: Yisheng Chen, Gurnee, IL (US); Guohua Zhang, Parsippany, NY (US)

Correspondence Address: Joseph A. Fuchs;Rockey, Depke & Lyons, LLC, 233 S. Wacker Drive, Suite 5450, Sears Tower, Chicago, IL, 60606-6306, US

(73) Assignee: NOVAST HOLDING LIMITED

(21) Appl. No.: 12/735,674

(22) PCT Filed: Feb. 25, 2009
(86) PCT No.: PCT/US09/35060

§ 371 Date: Sep. 21, 2010

(30) Foreign Application Priority Data
Mar. 4, 2008 (CN) 200810007337

(51) Int. Cl. G01N 1/12

(52) U.S. Cl. 73/864.64

(57) ABSTRACT

The present invention provides a powder sampling device having a rod and a member mounted on the rod. The rod has a first set of cavities, the first set of cavities having first cavity and a second cavity, the first cavity being positioned at generally the same axial location as the second cavity, the first cavity being circumferentially spaced from the second cavity such that the first cavity occupies a first radial position of the rod and the second cavity occupies a second radial position of the rod and the first radial position is different from the second radial position. The member is mounted to the rod and is moveable from an open position to collect a powder sample within the first cavity and the second cavity to a closed position to retain the powder sample in the first cavity and the second cavity.

### BACKGROUND OF THE INVENTION

1. Technical Field

The present invention relates to a tool for retrieving, retaining and releasing a sample of a powder material from a powder bed. More specifically, it relates to sampling of powder blends, especially pharmaceutical powder blends. Even more specifically, it relates to a sampling device or sampling thief, wherein multiple sets of three replicate powder samples can be taken at different depth positions within a powder bed with one single insertion and without changing the location of the device from where it was initially inserted into the powder bed.

2. Background Art

In the manufacturing of solid pharmaceutical dosage forms, one of the common steps is to blend active and inactive ingredients in a blender. Such powder blends are routinely sampled and tested to assess the powder mix uniformity. The

FDA draft guidance titled “Guidance for Industry, Powder Blends and Finished Dosage Units—Stratified In-Process Dosage Unit Sampling and Assessment” recommends taking blend samples from ten different locations with at least three replicates from each location. Currently, taking replicate samples is achieved by taking multiple samples sequentially, However such process is undesirable as it is very difficult to ensure the samples are taken from the same location. One sample thief described in U.S. Pat. No. 5,337,620 provides a number of cavities along a rod in horizontal alignment and spaced from one another and the rod is inserted into a tube have a number of horizontally aligned apertures. The rod is rotatable with respect to the tube to place the number of cavities on the rod simultaneously in alignment with the number of apertures on the tube such that when the thief is inserted into a powder bed a number of samples from a number of depths can be obtained. However, the sampling thief of the '620 Patent does not allow for the collection of replicate samples at each height location by a single sampling.

### SUMMARY OF THE INVENTION

The present invention provides a powder sampling device that allows a user of the device to take multiple samples from the same depth in a powder bed with a single insertion of the device into the powder bed. The device has a rod and a member mounted on the rod. The rod has a first set of cavities, the first set of cavities having first cavity and a second cavity, the first cavity being positioned at generally the same axial location as the second cavity, the first cavity being circumferentially spaced from the second cavity such that the first cavity occupies a first radial position of the rod and the second cavity occupies a second radial position of the rod and the first radial position is different from the second radial position. The member is mounted to the rod and is moveable from an open position to collect a powder sample within the first cavity and the second cavity to a closed position to retain the powder sample in the first cavity and the second cavity.

### BRIEF DESCRIPTION OF THE DRAWINGS

FIG. 1 is an assembly view of one preferred form of a powder sampling device of the present invention.

FIG. 2 is a cross-sectional view of the assembled device of FIG. 1.

FIG. 3 is a perspective view of another preferred embodiment of a powder sampling device of the present invention in partial assembly.

FIG. 4 is cross-sectional view taken along line 4-4 of the device shown in FIG. 3 but fully assembled.

FIG. 5 is a perspective view of a sliding plate.

FIG. 6 is an assembly view of another preferred form of a powder sampling device of the present invention.

FIG. 7 is a perspective view of the powder sampling device assembled in a closed position.

FIG. 8 is a view taken along line 8-8 of FIG. 7.

### DETAILED DESCRIPTION OF THE INVENTION

While this invention is susceptible of embodiment in many different forms, there is shown in the drawings, and will be described herein in detail, specific embodiments thereof with the understanding that the present disclosure is to be considered as an exemplification of the principles of the invention and is not intended to limit the invention to the specific embodiments illustrated. Other embodiments can be created by those skilled in the art based on the principles of the current invention set forth herein.

The present invention provides a powder sampling device having two principal parts that are moveable with respect to one another by relative rotational motion, translational motion or a combination of rotational and translational motion. In preferred forms of the invention the device can be changed from a closed position where all cavities are closed to a second position where two or more powder samples can be collected at the same depth within the powder bed, or wherein two or more samples can be collected at different depths within the powder bed, or wherein two or more duplicate samples can be collected from two different depths within the powder bed. For devices where two or more samples are simultaneously collected from differing depths within a powder bed, the device will be capable of movement to another position where the prior collected samples are retained within the device and at least one other sample is collected at the same depth as one of the prior collected samples. More preferably, for each sample collected at each depth a duplicate sample at that depth is collected while the prior samples are retained within the device.

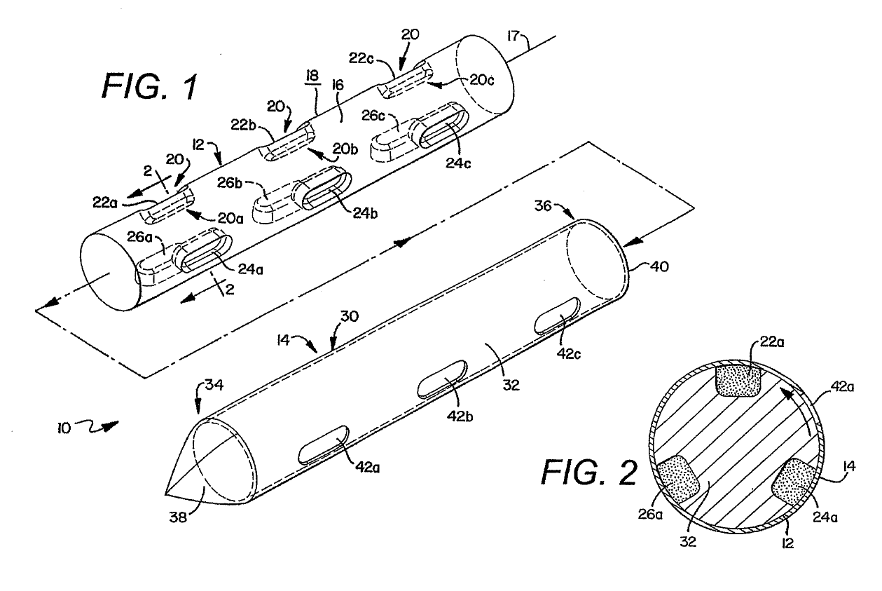

FIG. 1 shows one preferred form of the invention where the principal parts are capable of relative rotational motion. More specifically, FIG. 1 shows a powder sampling device or thief 10 having a rod 12 and a tube 14. The rod 12 has an axis 17 and an outer surface 18. In a preferred form of the invention the rod 12 will have two or more sets of sample collecting cavities 20, so that at least duplicate samples can be taken from two different depth positions. It is contemplated that the sampling device 10 could have a greater number of sets of cavities and that the number of cavities within a set can be two or greater.

The sampling device 10 of FIG. 1 has three sets of cavities with each set of cavities having three cavities for a total of nine cavities. Such a device is capable of taking triplicate samples from three different depth positions within the powder bed. FIG. 1 shows a first set, a second set and a third set of cavities respectively 20a, 20b, and 20c that are axially spaced from one another. Each set of cavities has three cavities 22, 24 and 26 that are circumferentially and evenly spaced from one another so that they occupy different radial locations on the outer surface 18 and form three sets of axially aligned (positioned along a straight line extending parallel to axis 17) cavities 22a,b,c; 24a,b,c; and 26a,b,c.

The tube 14 has a wall 30 defining a central lumen 32 (FIG. 2) and a first end 34 and a second end 36. The first end 34 terminates in a generally conically shaped member 38 to provide for ease of insertion of the thief 10 into a powder bed. The second end 36 has an opening 40 into the lumen 32 for receiving a portion of the rod 12 in telescoping fashion so that the rod and tube are concentrically disposed about axis 17. The tube 14 has an aperture 42 associated with each set of cavities so for devices having a rod with one set of cavities with two or more cavities in the set only a single aperture 42 is needed. In one preferred form of the invention shown in FIG. 1, the number of apertures 42 will be equal to the number of sets of cavities. In this embodiment, there are three sets of cavities 20a,b,c on the rod 12, and three apertures 42a,b,c on the tube 14. The apertures 42 extend through the thickness of the wall 30 to provide access to the lumen 32 or the cavities on the rod when positioned inside the lumen.

When the thief 10 is assembled by inserting the rod 12 within the opening 40 of the lumen 32 of the tube 14, the rod or the tube will be positionable with respect to the other by rotational motion. In a preferred form of the invention the thief can be placed in numerous configurations or positions including a first position where the apertures 42a,b,c are not in registration with any of the cavities of the rod, and, therefore all of the cavities are closed. This is a preferred position for inserting and removing the thief from a powder bed. The thief can be placed in a second, third and fourth position by respectively placing the apertures 42a,b,c into registration with cavities 22a,b,c (second position, first set of powder samples); 24a,b,c (third position, second set of powder samples); or 26a,b,c (fourth position, third set of powder samples).

To operate the thief of FIGS. 1 and 2, the thief will be placed in the first position where all cavities are closed. The thief is inserted into a powder bed to a depth where all of the cavities are below a surface of the powder bed. The rod or the tube is rotated with respect to the other to place the thief in position two to collect the first sample set including three samples from three different depth locations in the powder bed. The thief is then placed into the third position to collect the second set of three samples and to secure the first set of samples within their cavities. The thief is then placed in the fourth position to take a third set of three samples and to secure the first and second set of samples. The thief is then returned to the first position where all cavities are closed and three sets of three samples are retained within the thief. To retrieve the collected samples the process is repeated of moving the thief to the second, third and fourth positions but in this process the powder samples are removed and collected for testing.

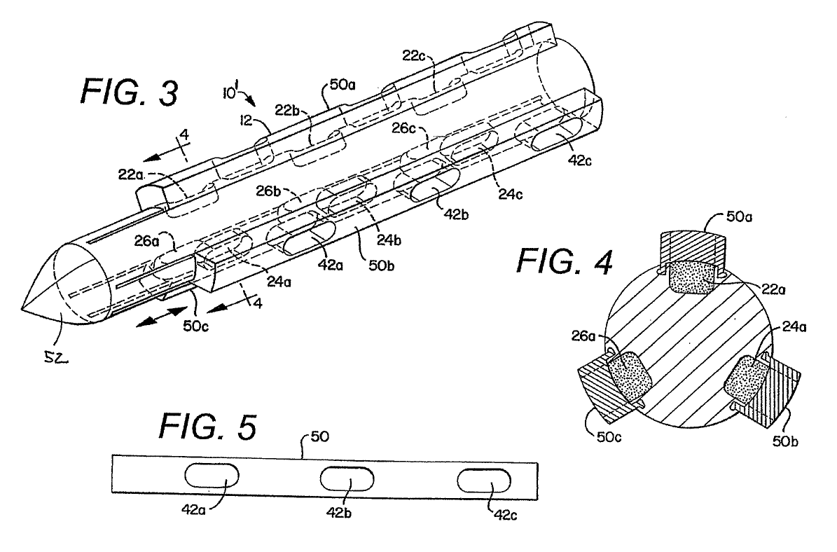

In a second preferred form of the invention shown in FIGS. 3-5, the principal parts retrieve and release samples through relative translational motion. More specifically, FIGS. 3-5 show another preferred sampling thief 10′. The same reference characters will be used to denote corresponding features of the thief 10 shown in FIGS. 1 and 2. The sampling thief 10′ replaces the tube 14 with three sliding plates 50a,b,c. In this embodiment the rod 12 will have a conical end 52. The sliding plates 50 are mounted to the outer surface 18 of the rod 12 for reciprocating, translational motion with respect to the rod. In one preferred form of the invention, the sliding plate will have a concave profile in cross section to conform to the curved outer surface of the rod. The sliding plates can also be flat. Each of the sliding plates will be moveable from a first closed position to an open position where apertures 42a,b,c of plates 50a,b,c will respectively be in registration with cavities 22a,b,c (second position, first set of powder samples); 24a,b,c (third position, second set of powder samples); or 26a,b,c (fourth position, third set of powder samples).

To operate the thief 10′ all of the sliding plates 50a,b,c will be moved to their first, closed position. A portion of the thief 10′ will be inserted into a powder bed so that all of the cavities are below a surface of the powder. The sliding plates 50a,b,c can be operated in any order to move each plate from the closed position to the open position to collect a sample in each cavity of the cavity set and then back to the closed position. Once all three plates have been operated the thief 10′ is removed from the powder sample and the process is reversed to remove the three sets of threes samples.

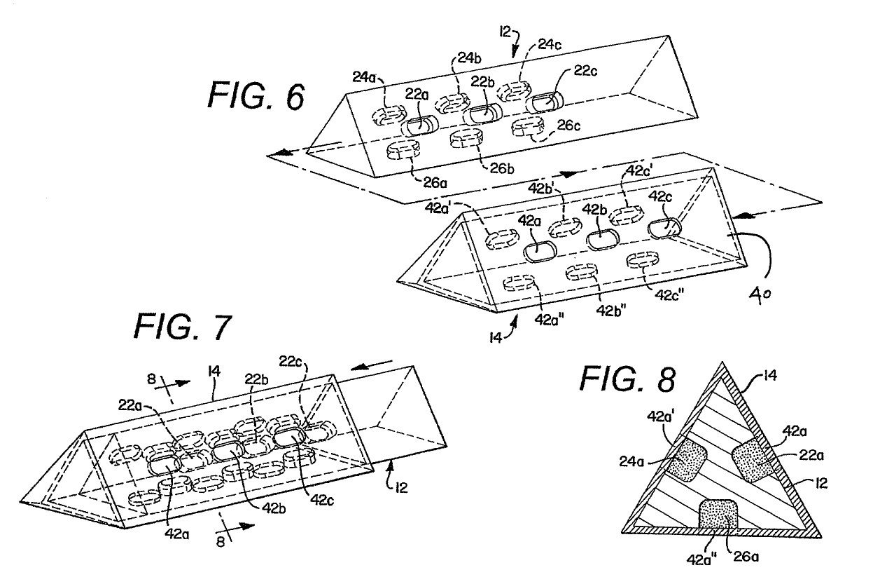

While the rod and tube of the sampling thief shown in FIGS. 1 and 2 have a circular shape in cross section, it is contemplated the rod and tube could have numerous shapes including oval, polygonal or irregular without departing from the scope of the present invention. In one preferred form of the invention shown in FIGS. 6-8, the rod 12 and the tube 14 have a triangular shape in cross section to define a triangular prism shaped rod and tube with a centrally disposed lumen. Such bodies, whether circular, oval, polygonal, irregular in cross sectional shape shall be referred to herein as tubes. The tube has three sets of cavities, one of each set of cavities is positioned on a face or wall of the triangular prism. Each set of cavities has two or more, and more preferably three cavities for a total of nine cavities. With polygons having greater number of sides than three, even a greater number of sets of cavities can be positioned on the faces of the polygon.

Similarly, the rod 14 has three sets of apertures 42a,b,c one of each associated with a wall of the triangle and each set of apertures having three apertures horizontally spaced from one another along a length of the tube with the second and third apertures in the set designated respectively with prime (′) and double prime (″). As shown in FIGS. 6-8 the rod 12 is inserted into the opening 40 of the lumen 32 of the tube 14 into a first position where none of the apertures 42 are in registration with any of the cavities 22, 24 or 26 to define a closed position. In one preferred form of the invention a stop will be provided within the lumen so the user of the device knows the rod is fully inserted and the device is in the closed position. The device 10 will be inserted and removed from a powder bed in this position.

By moving the rod 12 translationally with respect to the tube to a second position, where cavities 22a, 24a and 26a are brought respectively into registration with apertures 42a,a′,a″; and cavities 22b, 24b and 26b are brought into registration with apertures 42b,b′b″; and 22c, 24c and 26c are brought into registration with apertures 42c,c′,c″. In this position nine powder samples can be taken simultaneously. After the nine samples are taken the rod 12 is moved back to the stop position, to close all of the cavities and to retain the nine samples collected.

In another preferred form of the invention the principal parts retrieve and release samples through a combination of rotational motion and translational motion. Such motion can be provided by having mating threads positioned on interfacing portions of the tube and the rod.

It is contemplated any embodiment of the sampling thief 10 could be modified with cooperating features such that the thief can be indexed from one position to the next with a lock in each position. It is also contemplated that the thief can be biased into a closed position so that if the thief is dropped all of the cavities will be closed. It is also contemplated having a visual indication to the user of the device which position the device is in.

The shape and volume of the cavities can be varied according to the volume of the powder sample desired. In one preferred form of the invention each cavity is generally cylindrical, rectangular, hemispherical, a combination of hemispherical and rectangular, tablet-shaped, lozenge-shaped and bead-shaped to name a few. The shape and size of the apertures should have a size and shape that corresponds to the size and shape of an opening into the cavity.

The parts of the sampling thief can be fabricated from any suitable material for contact with pharmaceutical powders. It is contemplated fabricating the parts from metal, plastic, fiber glass, composite materials, and the combinations thereof. Suitable metals include stainless steel, aluminum and alloys. Suitable polymers include acetal resin such as those sold by DuPont under the tradename DELRIN, polytetrafluoroethylene (PTFE, Teflon), cyclic olefins, styrenes, acrylics, high density polyethylene (HDPE), polypropylene (PP), polyethylene teraphthalate (PET), and polyamides. Examples of polyamides include nylon 66, nylon 6 and others commonly available and known to those of ordinary skill in the art.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims

What is claimed is:

1. A powder sampling device comprising:
a rod having an outer surface, the rod having a first set of cavities, the first set of cavities having a first cavity and a second cavity, the first cavity being positioned at generally the same axial location as the second cavity, the first cavity being circumferentially spaced from the second cavity such that the first cavity occupies a first radial position of the rod and the second cavity occupies a second radial position of the rod and the first radial position is different from the second radial position; and
a member mounted to the rod and is moveable from an open position to collect a powder sample within the first cavity, the second cavity or both the first cavity and the second cavity, to a closed position to retain the powder sample in the first cavity and the second cavity.

2. The device of claim 1 wherein the member is positioned along a portion of the outer surface of the rod.

3. The device of claim 1 wherein the open position has a first position where the first cavity is open and the second cavity is closed and a second position where the second cavity is open and the first cavity is closed.

4. The device of claim 1 wherein when the device is in the open position both the first cavity and the second cavity are open to receive a sample.

5. The device of claim 1 wherein the member or the rod is capable of movement with respect to the other, in a manner selected from the group consisting of translational motion, rotational motion and a combination of translational and rotational motion.

6. The device of claim 5 wherein the rod has a cross-sectional shape selected from the group consisting of circular, oval, polygonal and irregular.

7. The device of claim 6 wherein a wall of the member has a portion removed to define an aperture that can be brought into registration with one of the first cavity or the second cavity to place the first cavity or the second cavity into the open position.

8. The device of claim 7 wherein the member is a plate mounted to the rod for reciprocating translational movement with respect to the rod.

9. The device of claim 8 wherein a number of plates is equal to a number of cavity sets.

10. The device of claim 7 wherein the member is a tube.

11. The device of claim 1 wherein the first set of cavities comprises a third cavity on the rod at generally the same axial location as the first cavity and the second cavity, the third cavity being positioned between the first cavity and the second cavity and spaced therefrom.

12. The device of claim 1 further comprising a second set of cavities on the rod and axially spaced from the first set of cavities.

13. The device of claim 12 wherein the second set of cavities comprises a fourth cavity, a fifth cavity and a sixth cavity, the fourth cavity being axially aligned with the first cavity, the fifth cavity being axially aligned with the second cavity and the sixth cavity being axially aligned with the third cavity.

14. The device of claim 13 further comprising a third set of cavities on the rod and axially spaced from the first set of cavities and the second set of cavities.

15. The device of claim 14 wherein the third set of cavities comprises a seventh cavity, an eighth cavity and a ninth cavity.

16. The device of claim 15 wherein the seventh cavity is axially aligned with the first cavity, the eighth cavity is axially aligned with the second cavity and the ninth cavity is axially aligned with the third cavity.
